(19) United States
(12) Patent Application Publication
(10) Pub. No.: US 2013/0311577 A1
(43) Pub. Date: Nov. 21, 2013

(54) Marketing Message Analysis and Reporting

(71) Applicants: Park S. Foreman, Summit, NJ (US); David K. Tam, Summit, NJ (US); David Shultz, Summit, NJ (US)

(72) Inventors: Park S. Foreman, Summit, NJ (US); David K. Tam, Summit, NJ (US); David Shultz, Summit, NJ (US)

(21) Appl. No.: 13/475,865

(22) Filed: May 18, 2012

(51) Int. Cl. G06F 15/16

(52) U.S. Cl. 709/206

(57) ABSTRACT

A system, software, or service that receives a message stream or feed representing the messages between senders and receivers forwarded from a service provider (client) to interpret and analyze messages for the collection of marketing data, and serve as a platform for direct marketing. Some of the System's capabilities can be used to collect usage data about service, product, or topics mentioned in messages, to collect demographic data from user's (sender/receiver or device) account information or based on content and context of messages, and to provide raw and analyzed data to the system's clients (messaging service provider or marketing entity). The System may also be used to send targeted messages to the user, and gather market data related to these direct messages.

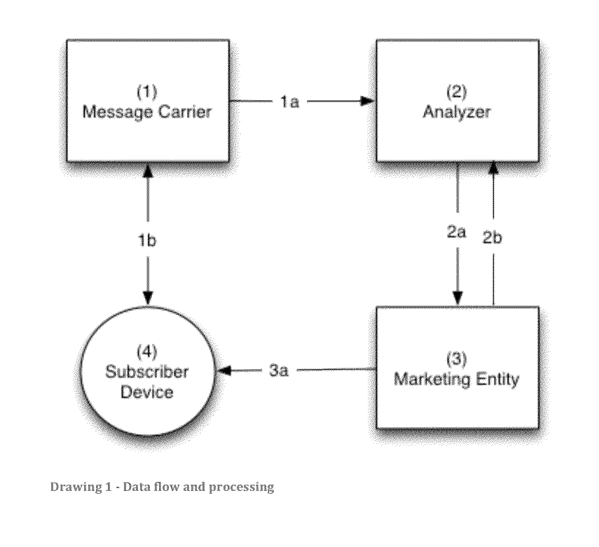

### BACKGROUND

The System may interact with several participants. The messaging service provider, (the entity or entities that provide the infrastructure and messaging service), provide a stream or feed of messages to the System, and may provide information about the message user (sender, receiver or device). In return, the service provider may receive revenue or marketing data about the message user. The message senders and receivers may subscribe or use an opt-in or opt-out feature to set personal marketing information and request delivery of direct marketing. Marketers and/or service providers may purchase marketing data derived from the activity of the message senders and receivers or may use the System as part of a direct marketing campaign.

### SUMMARY OF THE INVENTION

As messages are sent and received by a messaging system user, over a relevant period of time, the context and underlying interests of the user are analyzed. Based on this analysis and optionally a specified set of rules from a marketing customer, the operator of the messaging system provides relevant data identifying any combination of device identifier, account identifier and an indicator of their interests by a category, key word or subject area.

The System may provide a way for message users to subscribe to the service. It may also operate on all users of the message platform.

### DESCRIPTION OF DRAWINGS

Drawing 1 shows the data flow and processing from the origination of a message at the Message Carrier (1) to the delivery to the recipient/Subscriber Device (4). Key components of this invention are:
1. Comparison of the message sender with the list of subscribers of this carrier.
2. The Message Carrier takes a copy of the message sent or received and encodes it for transmission to the Analyzer (2).
   a. The Marketing Entity (3) receives marketing information from the analyzer in 2a. The Marketing entity can send rule details and subscriber information in 2b to the analyzer.
   b. The Subscriber Device (4) potentially receives marketing material from the marketing entity in 3a.

### DETAILED DESCRIPTION OF THE INVENTION

This invention relates in general to monitoring and alerting on message communications including but not limited to wireless, wired email, instant messages (IM) and short message service (SMS). Since messages are often shortened or abbreviated for efficiency, they can be more difficult to analyze or interpret. This invention is intended to address that problem and monitor for non-compliance, safety or security threat based on this abbreviated type of content.

### Description of Related Art

Messages are commonly transmitted from one party to another over some type of network media such as wireless or wired media using protocols such as Transmission Control Protocol (TCP), Internet Protocol (IP), Simple Mail Transport Protocol (SMTP), Extensible Messaging and Presence Protocol (XMPP) and Short Message Peer-to-Peer Protocol (SMPP). The owner, operator account holder of either the sending or receiving infrastructure, service or account (hereinafter referred to as a subscriber) sometimes analyzes these messages in transmission. These owners or operators are hereinafter referred to as carriers.

The subscribers to devices, software and systems that originate or receive messages also have an interest in reducing costs in exchange for allowing analysis of their messages individually or over a period of time for the purposes of having relevant products and services offered to them in the same messaging system or other media.

### Technical Problem

Identifying the possible interests of the participants in a message conversation (subscribers) is essential in being able to offer the most relevant products and services. The interests of the subscribers over a recent period are more precisely understood than in a single point in time or in a single message. Message monitoring systems attempt statistical analysis and simple phrase comparison to identify interests. However, it is more useful to understand the interests of an individual depending on the context and time frame of the messages analyzed.

The identification of messages to be analyzed is typically performed at the sending station or the receiving station. The monitoring mechanism can be tampered with or subverted by the sender or receiver. Also, the sending and receiving sides can incur more bandwidth usage to deliver a copy of the message to a monitoring and analysis system.

### Solution to Problem

Copies of messages sent and received by a subscriber are forwarded to an analysis engine along with identifying non-personal information hereinafter referred to as a subscriber id. This identification might be an Internet domain name, account number, phone number, IP address or other such information that does not include the subscribers name or address.

Once the message copies are securely transmitted between the carrier and the message analyzer, the message is analyzed for content, context and area of interest over a specified period of time. This analysis may be supplemented by linguistic consultation and context-specific analysis.

Agreements with marketing entities specify which areas of interest are to be identified. For example, a marketing company may wish to know when the conversations of a subscriber are indicating interest in consumer electronics equipment or gourmet food. Those interests may by revealed in the message analysis as being either positive or negative.

On request, the marketing entity can request the preferences status of a particular subscriber through the subscriber id. In response, the current interests are provided so that immediate, relevant marketing content can be delivered to the subscriber as desired by the marketing entity.

### INDUSTRIAL APPLICABILITY

This patent can apply to any message creation and delivery mechanism. Potential industries include: telecommunications, data communications, cell-phone text-messaging, e-mail systems, instant messenger applications and other peer to peer or broadcast messages. The analytical capabilities defined in this patent can pertain to marketing, sales and regulatory compliance.

What is claimed is:

1: A data processing system, Analyzer (2), for receiving copies of messages sent or received (1a) by the Subscriber Device (4) using the resources of the Message Carrier (1). The data processing system comprises: one or more processors, one or more computer-readable memories and one or more computer-readable, tangible storage devices; program instructions, stored on at least one of the one or more storage devices for execution by at least one of the one or more processors via at least one of the one or more memories to analyze messages over a time frame and convey the results (2a) of the analysis to the Marketing Entity (3).

2: The analysis in claim 1 is compromised of a service or data processing system, Analyzer (2), that
a. Collects the conversation messages over a period of time specified in a variable or fixed configuration.
b. The Analyzer (2) optionally translates the content of the message into the assumed native language.
c. The Analyzer (2) recognizes context based on a & b.
d. The Analyzer (2) performs a natural language analysis of the messages from any combination of a, b and c.

3: Rules specifying types of subscriber preferences (marketing data) to be reported the Marketing Entity (3) are established through either manual or automated means. Upon request (2b) of the Marketing Entity (3) to the Analyzer (2), the preferences matching the rules and the subscriber id are reported (2a). The Marketing entity may then perform actions as needed by supplying relevant marketing information (3a) to the Subscriber Device(4). Marketing data is defined as all data that explains, defines, or conjectures words, phrases, or context from messages that can be of relevance to a marketing entity.

4: Claims 1, 2 and 3 can be applied to individual users or groups of users based on identification. The system may identify individual users or groups of users by:
a. the known or derived usage graph of the message user
b. by known or derived demographic data about a message user
c. any and all message users
